(19) United States
(12) Patent Application Publication
(10) Pub. No.: US 2015/0203062 A1
(43) Pub. Date: Jul. 23, 2015

(54) METHODS AND SYSTEMS FOR CUSTOM VEHICLE PERSONALIZATION VIA HUMAN MACHINE INTERFACE

(71) Applicant: GM GLOBAL TECHNOLOGY OPERATIONS LLC, Detroit, MI (US)

(72) Inventors: NEERAJ R. GAUTAMA, WHITBY (CA); JARVIS CHAU, MARKHAM (CA); AMANDA J. KALHOUS, AJAX (CA); MARK A. MANICKARAJ, AJAX (CA)

(73) Assignee: GM GLOBAL TECHNOLOGY OPERATIONS LLC, Detroit, MI (US)

(21) Appl. No.: 14/158,526

(22) Filed: Jan. 17, 2014

(51) Int. Cl. B60R 16/037

(52) U.S. Cl. CPC B60R 16/037

(57) ABSTRACT

Methods and systems are provided for managing a user profile of a vehicle. In one embodiment, a method comprises: generating data for displaying a selection screen of a graphical user interface in the vehicle; receiving profile personalization data based on a user interacting with the selection screen; creating a user profile based on the profile personalization data; and storing the user profile in a user profile datastore of the vehicle.

### TECHNICAL FIELD

The technical field generally relates to methods and systems for creating user profiles for a vehicle, and more particularly to methods and systems for creating, storing, and using user profiles for a vehicle.

### BACKGROUND

In-vehicle information systems have become commonplace in vehicles such as automobiles, trucks, sport utility vehicles, etc. The information systems typically provide navigation information, entertainment information (e.g., information associated with the radio, CD player, DVD player, etc.), and other information of the vehicle. In some instances, the information systems may be used to configure the settings of individual components of the vehicle (e.g., positions of seats, steering wheel column, mirrors, thermostat controls, audio tuner settings and volume, etc.). The settings for any one particular driver may vary based on driving conditions. For example, the driver's preferences of the settings may vary based on where the driver is driving, based on who is in the vehicle with the driver, based on a time of day the driver is driving, etc. Likewise, the settings for one particular driver may be different than the settings for another driver.

Accordingly, it is desirable to provide methods and systems for creating and storing user profiles for a vehicle such that they can be managed for any particular user. In addition, other desirable features and characteristics of the present invention will become apparent from the subsequent detailed description and the appended claims, taken in conjunction with the accompanying drawings and the foregoing technical field and background.

### SUMMARY

Methods and systems are provided for managing a user profile of a vehicle. In one embodiment, a method comprises: generating data for displaying a selection screen of a graphical user interface in the vehicle; receiving profile personalization data based on a user interacting with the selection screen; creating a user profile based on the profile personalization data; and storing the user profile in a user profile datastore of the vehicle.

In another embodiment, a system comprises a display device and a control module. The display device displays a selection screen of a graphical user interface in the vehicle. A control module receives profile personalization data based on a user interacting with the selection screen, creates a user profile based on the profile personalization data, and stores the user profile in a user profile datastore of the vehicle.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a user profile management system that includes a wireless end device and a vehicle in accordance with various embodiments;

FIG. 2 is a dataflow diagram illustrating a control module of the user profile management system in accordance with various embodiments;

FIGS. 3A and 3B are illustrations of an interactive interface of the user profile management system in accordance with various embodiments; and

FIGS. 4-5 are flowcharts illustrating user profile management methods that may be performed by the user profile management system of FIG. 1 in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

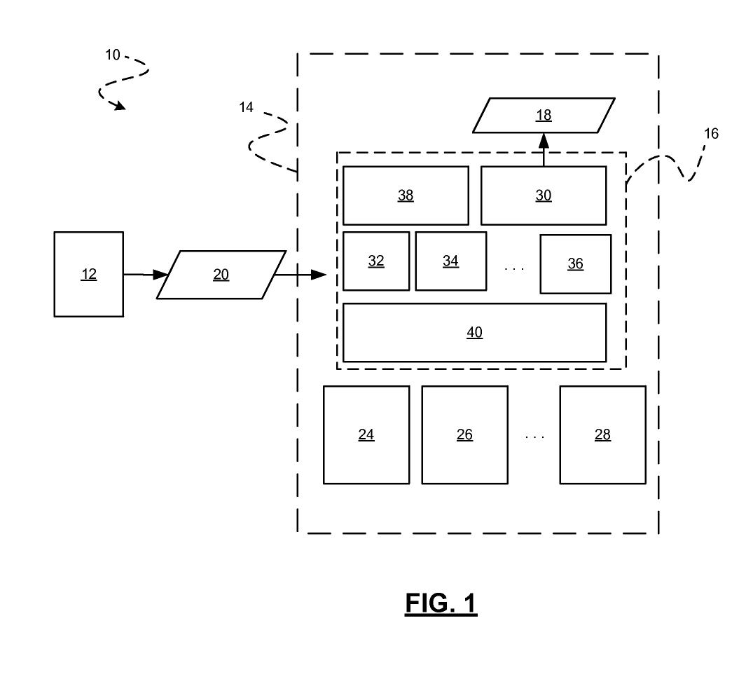

FIG. 1 is a functional block diagram of a user profile management system 10 in accordance with various embodiments. Although the figures shown herein depict an example with certain arrangements of elements, additional intervening elements, devices, features, or components may be present in actual embodiments. It should also be understood that FIG. 1 is merely illustrative and may not be drawn to scale.

As shown, the user profile management system 10 includes a wireless end device (WED) 12 that is configured to communicate with a vehicle 14. The WED 12 may be a smart phone, a tablet, a Bluetooth enabled gadget, or any other electronic device that is capable of communicating with the vehicle 14 using a short range and/or long range communication protocol. The vehicle 14 may be an automobile, an aircraft, a spacecraft, a watercraft, a sport utility vehicle, or any other type of vehicle.

The vehicle 14 includes an infotainment system 16 (among other elements not shown) that displays information (i.e., navigation and other vehicle information) to a user of the system through an interactive interface 18 that is graphical in nature. In general, the WED 12 communicates an identifier 20 of the WED 12 to the infotainment system 16 of the vehicle 14 and the infotainment system 16 or other system of the vehicle 14 identifies the WED 12 based on the identifier 20. The infotainment system 16 creates and manages user profiles for the vehicle 14 based on the identified WED. Each user profile includes one or more settings for one or more components 24-28 of the vehicle 14. The components 24-28 can include, for example, but are not limited to, a seat, a mirror, a steering system, a pedal system, an audio system, a lighting system, a heating system, a ventilation system, an air-conditioning system, a window, a sunroof, windshield wipers, etc. The settings of the components can include, for example, but are not limited to, seat position (driver and/or passenger), mirror position (side-view and/or rear-view mirrors), steering column, pedal positions, audio system (stations, favorite stations, initial radio station, volume control, equalizer settings), interior lighting, heating, ventilation, and air conditioning (HVAC) controls (temperature settings, dual-zone temperature settings, blower function, A/C on-off, rear-seat zone temperature, heated/cooling seats), window positioning (ventilation to full-open), sunroof positioning, driving mode (sport, touring, eco-mode), windshield wipers mode, rear-windshield defrost, DIC (Driver Information Center) information (show speedometer, oil life, fuel remaining, tire pressure), trip vehicle information reset (trip odometer, average fuel consumption, average speed, trip timer), trip metrics for country (e.g., KPH/MPH), Celsius, Fahrenheit), and Heads up Display (HUD) (lighting, information, position).

In order to manage the user profiles, the infotainment system 16 generally includes a display device 30 one or more user input devices 32-36, a global positioning system (GPS) device 38, and a control module 40. The display device 30 may be any display device capable of displaying the interactive interface 18, such as a suitably configured liquid crystal display (LCD), plasma, cathode ray tube (CRT), or heads-up display. The input devices 32-36 may be any input device capable of receiving input from a user when interacting with the interactive interface 18. In various embodiments, the input devices 32-36 may be a part of the display device 30 such as, but not limited to, touch screen sensors, and/or may be separate from the display device 30 such as, a keyboard or keypad, a voice recognition system, a cursor control device, a joystick or knob, or a selection button that is associated with the display device 30.

The GPS device 38 communicates with GPS satellites (not shown) to derive a current location (e.g., latitude and longitude coordinates) of the vehicle 14, a current time, and, in some instances, to determine map information associated with the current location of the vehicle 14. The GPS device 38 provides the GPS information to the control module 40.

The control module 40 interacts with the user input devices 32-36 and the GPS device 38 to create any number of user profiles. For example, any number of user profiles may be configured for a particular user that is associated with the identified WED. As will be discussed in further detail below, based on the user profiles, the control module 40 generates messages on a communication bus and/or generates control signals to the components 24-28 to cause one or more components 24-28 of the vehicle 14 to operate at a particular setting. In various embodiments, the control module 40 selects a particular user profile for use based on a current location of the vehicle 14 or time as identified by the GPS device 38.

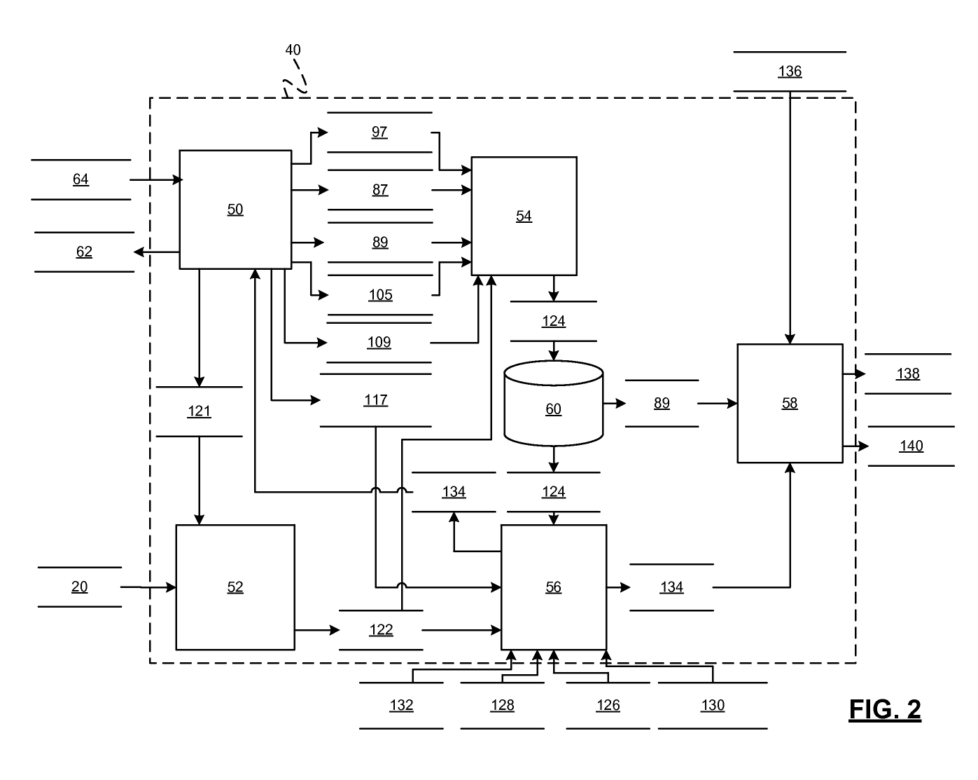

Referring now to FIG. 2 and with continued reference to FIG. 1, a dataflow diagram illustrates the control module 40 in accordance with various embodiments. Various embodiments of the control module 40 according to the present disclosure may include any number of sub-modules. As can be appreciated, the sub-modules shown in FIG. 2 may be combined and/or further partitioned to similarly create and manage user profiles of the vehicle 14. Inputs to the control module 40 may be received from the GPS device 38, received from the input devices 32-36, received from other control modules (not shown) of the vehicle 14, and/or determined by other sub-modules (not shown) of the control module 40. In various embodiments, the control module 40 includes a user interface manager module 50, a user identifier module 52, a profile creator module 54, a profile manager module 56, a settings manager module 58, and a user profile datastore 60.

The user interface manager module 50 generates user interface data 62. The user interface data 62 is used to display all or parts of the interactive interface 18. The user interface manager module 50 receives as input user input data 64 that is generated by a user when interacting with the interactive interface 18 via one or more of the user input devices 32-36.

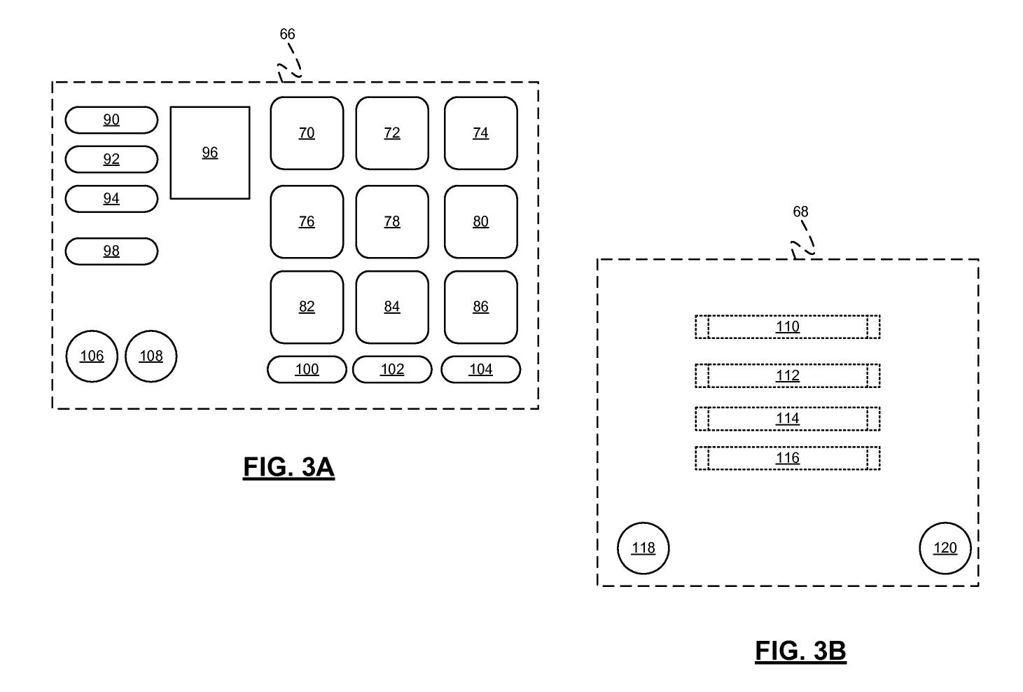

As shown in FIGS. 3A and 3B (and with continued reference to FIGS. 1 and 2), the interactive interface 18 includes one or more selection screens 66 and one or more notification screens 68. In general, the selection screen(s) 66 includes any number of component selection items 70-86 (e.g., selection boxes, selection lists, drop-down menus, etc.) that, when selected, generate data 87 indicating a selected component and that cause a settings selection screen (not shown) for selecting particular settings of the component to be displayed. The settings selection screen includes, for example, and any number of settings selection items (e.g., selection boxes, selection lists, drop-down menus, etc.) that, when selected, generate data 89 indicating selected settings for the components 24-28.

In various embodiments, the selection screen(s) 66 includes profile personalization selection items 90-96 (e.g., selection boxes, text boxes, selection lists, drop-down menus, etc.) that, when selected, generate data 97 indicating a profile name, a profile picture, a profile theme, a profile color, a profile chime, a profile song, or other characteristics to be associated with the user profile for identification. In various embodiments, the selection screen(s) 66 includes activation selection items 98-104 (e.g., selection boxes, text boxes, selection lists, drop-down menus, etc.) that, when selected, generate data 105 indicating a time (e.g., a specific time, or a default time) or event for activating the user profile, a location for activating the user profile, and/or a voice or speech tag for activating the user profile. For example, the user profile can be configured to be activated when the current time reaches a selected time (or timeframe), when the current location reaches a selected location (or vicinity), when received voice or speech data matches selected voice or speech data, and/or based on a default event (e.g., activate when the particular user is identified). In various embodiments, the selection screens(s) 66 includes profile acceptance selection items 106-108 (e.g., selection boxes, text boxes, selection lists, drop-down menus, etc.) that, when selected, generate data 109 indicating whether to save or delete the created user profile.

The notification screen(s) 68, in general, includes any number of notification items 110-116 (e.g., textual notifications, graphical notifications, etc.), that notify the user of information associated with a current user profile. The information can include, for example, the name (or any other personalization information) of the current user profile and an activation time or event of the current user profile. In various embodiments, the notification screen(s) 68 includes any number of acceptance selection items 118-120 (e.g., selection boxes, selection lists, drop-down menus, etc.) that, when selected, generate data 117 indicating whether or not to activate the settings associated with a current user profile.

The user identifier module 52 receives as input the identifier 20 that is communicated by the WED 12. Alternatively, the user identifier module 52 receives as input user selection data 121 that may be generated based on a user's interaction with the interactive interface 18 and that indicates a particular user. The user identifier module 52 determines a current user 122 of the system based on the received input. For example, when the user identifier module 52 receives the identifier 20 from the WED 12, the user identifier module 52 associates the identifier 20 with a particular user and sets the current user 122 to the associated user. In various embodiments, the association of the WED 12 and the user may be based on a pre-pairing process that is performed between the WED 12 and the vehicle 14. In another example, when the user identifier module 52 receives the user selection data 121, the user identifier module 52 sets the current user 122 to the selected user that is indicated by the user selection data 121.

The profile creator module 54 receives as input the components data 87, the settings data 89, the personalization data 97, the activation data 105, the acceptance data 109, the current user 122, and/or any other data determined from a user interacting with the interactive interface 18. The profile creator module 54 creates a user profile 124 based on the personalization data 97. For example, the user profile 124 can be created with a particular name, a particular theme, a particular profile picture, etc. The profile creator module 54 then associates the settings data 89 for the selected components of the components data 87 and the activation data 105 with the user profile 124.

When the acceptance data 109 indicates to save the user profile 124, the profile creator module 54 stores the user profile 124 in the user profile datastore 60 for future use. When the acceptance data 109 indicates to delete the user profile 124, the profile creator module 54 deletes the user profile 124. In various embodiments, the profile creator module 54 creates and stores any number of user profiles 124 for a single current user 122; and the profile creator module 54 creates and stores user profiles 124 for any number of users.

The profile manager module 56 receives as input the profile acceptance data 117, the current user 122, voice or speech data 126, location data 128, remote user selection data 130, and/or time data 132. The voice or speech data 126, for example, includes data indicating a selected user profile that may generated by a user when interacting (by speech) with a user input device 32-36 of the infotainment system 16, such as a microphone. The location data 128, for example, includes data indicating a current location of the vehicle 14 and may be generated by the GPS device 38. The remote user selection data 130, for example, includes data indicating a selected user profile that may generated by a user interacting with the infotainment system 16, by an email from an electronic mail system, by a text message generated by a text messaging system, or by any other messaging system. The time data 132, for example, includes data indicating a current time and may be generated by the GPS device 38 or other time keeping system.

The profile manager module 56 selects a user profile 124 based on one or more of the received data. For example, the profile manager module 56 retrieves the user profiles 124 associated with the current user 122 from the user profile datastore 60 and sets a current profile 134 to one of the profiles associated with the user. The profile manager module 56 sets the current profile 134 based on a comparison of the event or time of the user profile (defined by the activation data 105) to the voice or speech data 126, the location data 128, the remote user selection data 130, and/or the time data 132. For example, the profile manager module 56 sets the current profile 134 to a profile that has a speech or voice tag that matches speech or voice data 126. In another example, the profile manager module 56 sets the current profile 134 to a profile that has an activation time that matches (or is within a timeframe of) the time data 132. In still another example, the profile manager module 56 sets the current profile 134 to a profile that has an activation location that matches (or is within a determined distance) from the location data 128. In still another example, the profile manager module 56 sets the current profile 134 to a profile that has been selected by the user via the remote user selection data 130 (e.g., regardless of any associated activation time or event).

The profile manager module 56 provides the current profile 134 to the user interface manager module 50 for display of the notification screen. The profile manager module 56 receives, in return, the profile acceptance data 117 that indicates whether or not to accept the current user profile 134. The profile manager module 56 provides the current user profile 134 to the settings manager module 58 when the profile acceptance data 117 indicates to accept the current user profile 134.

The settings manager module 58 receives as input the current user profile 134, and a vehicle status 136. The vehicle status 136 indicates a current operating condition of the vehicle 14 (e.g., a current range of park, reverse, neutral, drive, or any other operating condition of the vehicle 14). The settings manager module 58 retrieves the settings data 89 stored for the current user profile 134 and generates messages 138 and/or control signals 140 such that the one or more components 24-28 may be controlled to the selected settings indicated by the settings data 89. In various embodiments the settings manager module 58 generates the messages 138 and/or the control signals 140 when the vehicle status 136 indicates a particular status (e.g., when the vehicle is operating in park, or other operating status).

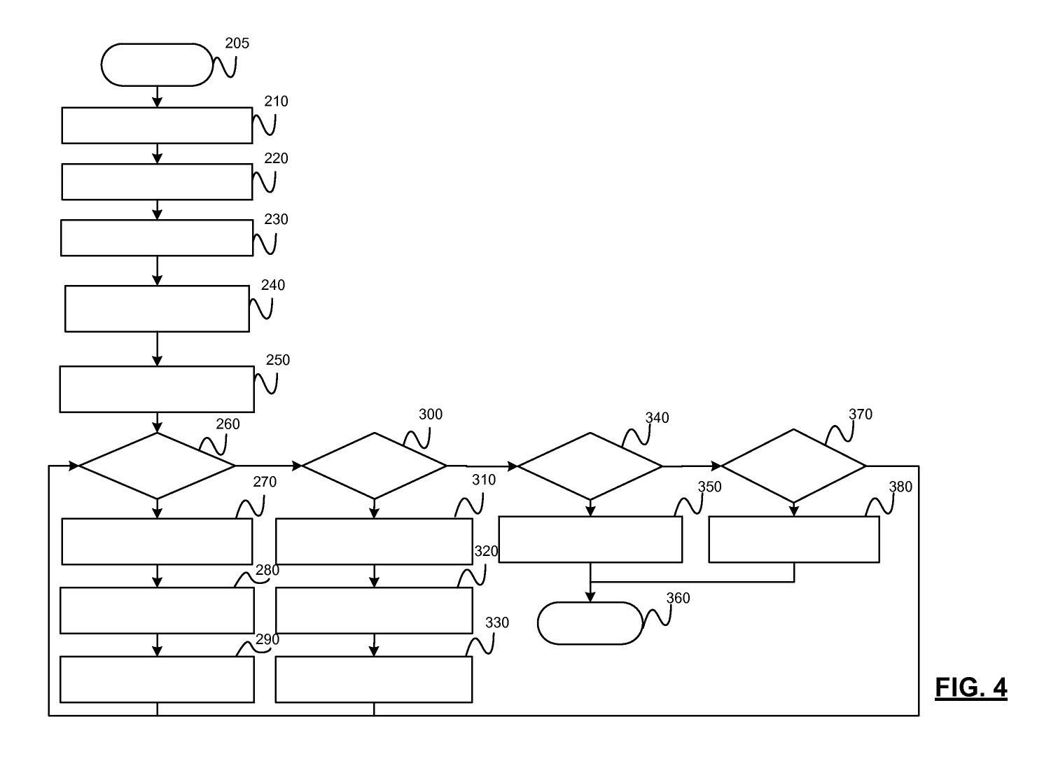

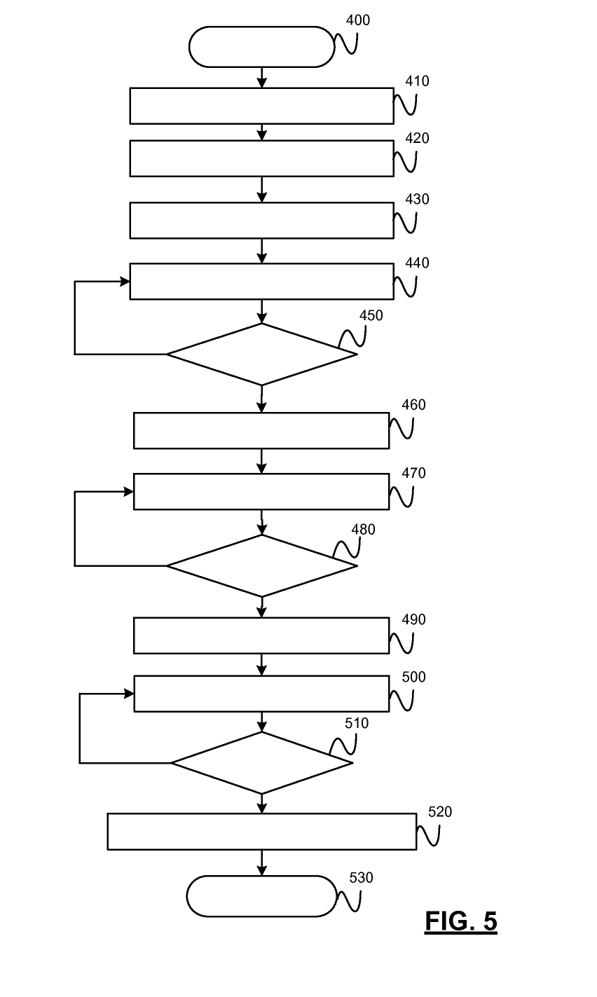

Referring now to FIGS. 4-5 and with continued reference to FIGS. 1-2, flowcharts illustrate profile managements methods that may be performed by the user profile management system 10 in accordance with various embodiments. As can be appreciated in light of the disclosure, the order of operation within the methods is not limited to the sequential execution as illustrated in FIGS. 4-5, but may be performed in one or more varying orders as applicable and in accordance with the present disclosure. As can further be appreciated, one or more steps of the methods may be added or removed without altering the spirit of the method.

With reference to FIG. 4, a flowchart illustrates exemplary sequences of steps of a method for creating a user profile 124 in accordance with exemplary embodiments. The method may begin at 205. The identifier 20 is received from the WED 12 at 210. The current user 122 is determined based on the identifier 20 at 220. The selection screen 66 is displayed at 230. The personalization data 97 including a profile name, a profile picture, a profile theme, or other information is received at 240 based on a user interacting with the selection screen 66. The user profile 124 is created based on the current user 122 and the personalization data 97 at 250. If components data 87 is received and indicates that a component 24-28 has been selected by a user interacting with the selection screen 66 at 260, a selection screen that displays selectable settings for the component 24-28 is displayed at 270. The settings data 89 is received at 280 based on a user's interaction with the settings selection screen 66. The settings selection data 89 for the components 24-28 are then associated with the user profile 124 at 290.

If, at 260, the components data 87 is not received, it is determined whether the activation data 105 is received at 300. If the activation data 105 is received and indicates that an activation setting is selected at 300, an activation selection screen that displays selectable settings for the activation of the user profile 124 is displayed at 310. The user selected activation data 105 is received at 320 based on a user's interaction with the activation selection screen. The activation data 105 is then associated with the user profile 124 at 330.

If, at 260, the components data 87 is not received, and at 300 the activation data 105 is not received, it is determined whether acceptance data 109 is received at 340. If the acceptance data 109 is received and indicates to save the user profile 124 at 340, the user profile 124 and the associated settings data 87 and the activation data 105 is saved in the user profile datastore 60 at 350 and the method may end at 360.

If, at 260, the components data 87 is not received, at 300 the activation data 105 is not received, and at 350 the acceptance data 109 does not indicate to save the user profile 124, it is determined whether the acceptance data 109 indicates to delete the current profile at 370. If the acceptance data 109 indicates to delete the user profile 124, the user profile 124 and the associated data is deleted and the method may end at 360. If, however, the acceptance data 109 does not indicate to delete the user profile 124, the method continues to monitor the received data at 260.

With reference to FIG. 5, a flowchart illustrates exemplary sequences of steps of a method for managing user profiles in accordance with exemplary embodiments. The method may begin at 400. The identifier 20 is received from the WED 12 at 410. The current user 122 is determined based on the identifier 20 at 420. The user profiles 124 that match the current user 122 of the vehicle status are retrieved from the user profile datastore 60 at 430. The activation conditions (e.g., time, location, speech or voice tag, default, etc.) associated with the user profiles 124 are monitored at 440. If the current conditions do not match an activation condition of one of the user profiles 124 at 450, the method continues with checking the activation conditions at 440.

If, however, the current conditions match an activation condition of a user profile 124 at 450, the current user profile 134 is set to the profile associated with the activation condition at 460. A notification screen 68 is generated that includes, for example, the profile name, the time of activation, and the acceptance selection items 118-120. If, at 480, profile acceptance data 117 is received based on a user's interaction with the notification screen 68, the component settings are determined from the components data 87 of the current user profile 134 at 390 and the vehicle status 136 is monitored at 500. If the vehicle status 136 meets a particular status at 510, the messages 138 and/or the control signals 140 are generated based on the settings at 520. Thereafter, the method may end at 530. If, however, the vehicle status 136 does not meet the particular status at 510, the method continues with monitoring the vehicle status 136 at 500.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of managing a user profile of a vehicle, comprising:
generating data for displaying a selection screen of a graphical user interface in the vehicle;
receiving profile personalization data based on a user interacting with the selection screen;
creating a user profile based on the profile personalization data; and
storing the user profile in a user profile datastore of the vehicle.

2. The method of claim 1 wherein the creating comprises creating a plurality of user profiles based on a current user and the profile personalization data, and wherein the storing comprises storing the plurality of user profiles in the user profile datastore of the vehicle.

3. The method of claim 1 further comprising:
receiving an identifier of a wireless end device; and
determining a current user based on the identifier of the wireless end device, and wherein the creating is based on the current user.

4. The method of claim 1 further comprising:
receiving an identifier of a wireless end device;
determining a current user based on the identifier of the wireless end device; and
selecting a user profile from a plurality of user profiles stored in the user profile datastore based on the current user.

5. The method of claim 1 further comprising:
receiving settings data indicating desired settings of a component of the vehicle based on a user interacting with the graphical user interface of the vehicle; and
associating the settings data with the user profile.

6. The method of claim 1 further comprising:
receiving activation data indicating activation conditions for activating the user profile based on a user interacting with the graphical user interface of the vehicle; and
associating the activation data with the user profile.

7. The method of claim 6 wherein the activation data includes at least one of an activation location and an activation vicinity of a location.

8. The method of claim 7 further comprising:
monitoring a current location; and
generating a notification screen based on the current location and the at least one of the activation location and the activation vicinity of a location.

9. The method of claim 7 further comprising:
monitoring a current location; and
generating at least one of messages and control signals to control one or more settings of one or more components of the vehicle based on the monitoring.

10. The method of claim 6 wherein the activation data includes at least one of an activation time and an activation timeframe.

11. The method of claim 10 further comprising:
monitoring a current time; and
generating a notification screen based on the current time and the at least one of the activation time and the activation timeframe.

12. The method of claim 10 further comprising:
monitoring a current time; and
generating at least one of messages and control signals to control one or more settings of one or more components of the vehicle based on the monitoring.

13. The method of claim 6 wherein the activation data includes at least one of voice data and speech data.

14. The method of claim 13 further comprising:
receiving at least one of speech input data and voice input data from a user; and
generating a notification screen based on a comparison of the at least one of the voice data and the speech data with the at least one of the speech input data and the voice input data.

15. The method of claim 13 further comprising:
receiving at least one of speech input data and voice input data from a user; and
generating at least one of messages and control signals to control one or more settings of one or more components of the vehicle based on the at least one of the speech input data and the voice input data.

16. The method of claim of claim 1 further comprising:
receiving remote selection data from at least one of an email messaging system and a text messaging system, wherein the remote selection data indicates a selection of a user profile; and
generating a notification screen based on the remote selection data.

17. The method of claim 1 further comprising:
monitoring a vehicle operational status; and
generating at least one of messages and control signals to control the component to the settings based on the vehicle operational status.

18. The method of claim 1 wherein the profile personalization data includes data indicating at least one of a profile name, a profile theme, a profile picture, a profile color, a profile chime, and a profile song.

19. A system for managing a user profile of a vehicle, comprising:
a display device that displays a selection screen of a graphical user interface in the vehicle; and
a control module that receives profile personalization data based on a user interacting with the selection screen, that creates a user profile based on the profile personalization data, and that stores the user profile in a user profile datastore of the vehicle.

20. The system of claim 19 wherein the control module creates a plurality of user profiles based on a current user and the profile personalization data, and wherein the storing comprises storing the plurality of user profiles in the user profile datastore of the vehicle.
